(19) United States
(12) Patent Application Publication
(10) Pub. No.: US 2024/0405456 A1
(43) Pub. Date: Dec. 5, 2024

(54) Outer Conductor Contact Element

(71) Applicant: Rosenberger Hochfrequenztechnik GmbH & Co. KG, Fridolfing (DE)

(72) Inventor: Hubert Speckbacher, Fridolfing (DE)

(21) Appl. No.: 18/732,993

(22) Filed: Jun. 4, 2024

(30) Foreign Application Priority Data
Jun. 5, 2023 (EP) 23 177 159.3

(51) Int. Cl. H01R 9/05; H01R 43/04

(52) U.S. Cl. CPC H01R 9/0518; H01R 43/04

(57) ABSTRACT

An outer conductor contact element for an electrical connector assembly has a first crimping portion for crimping an outer conductor of an electrical cable inserted inside the outer conductor contact element to the outer conductor contact element. The first crimping portion has two opposing crimping flanks, which fully circumferentially crimp the outer conductor in a final assembly state. In the final assembly state, a finger-shaped extension is formed on a side edge of one crimping flank and a corresponding finger-shaped recess is formed on a side edge of the other crimping flank, into which the finger-shaped extension is engaged. The finger-shaped extension and the finger-shaped recess each have at least one longitudinal extension portion with a directional component in a longitudinal axial direction L of the outer conductor contact element and with a directional component transverse to the longitudinal axial direction L.

### CROSS-REFERENCE TO RELATED APPLICATIONS

This US National Stage Non-Provisional Utility patent application claims priority to earlier filed European Patent Application No. 23 177 159.3, which was filed on 5 Jun. 2023. The entire contents of the aforementioned earlier filed European Patent Application is expressly and fully incorporated herein by this reference.

Pursuant to USPTO rules, this priority claim to earlier filed European Patent Application No. 23 177 159.3, which was filed on 5 Jun. 2023, is also included in the Application Data Sheet (ADS) filed herewith.

### FIELD OF THE INVENTION

The present invention relates to an outer conductor contact element.

The present invention also relates to an electrical connector assembly, having an electrical cable and an electrical connector electrically and mechanically connected to the electrical cable and containing the outer conductor contact element.

Still further, the present invention relates to a method for producing the electrical connector assembly.

### BACKGROUND OF THE INVENTION

The electrical and mechanical connection between the outer conductor of an electrical cable and the outer conductor contact element of an electrical connector is usually made via a crimp connection.

The outer conductor of an electrical cable, which is typically braided from several metal wires made from a material such as, but not limited to, copper, and in the form of a sleeve, is exposed from a cable sheath at the electrical cable's plug end, and the outer conductor is folded back around a support sleeve that is preferably formed of a metal. To create the crimp connection on the outer conductor side between the folded-back outer conductor of the electrical cable and the outer conductor contact element of the connector, the outer conductor contact element is designed as a crimp sleeve that fully encases the outer conductor of the electrical cable and is crimped to it. For cost reasons, the use of a crimp sleeve produced using stamping and bending technology has become established in recent years. In a first production variant of a connector assembly, the planar stamping pattern of the crimp sleeve is bent in such a way that in a pre-assembled state the crimp sleeve forms a U-shaped cross-sectional profile with its crimping flanks with an opening for inserting the electrical cable at the side. The two crimping flanks are then bent to a final assembly state in such a way that the crimp sleeve fully encloses the electrical cable and the outer conductor of the electrical cable is fully crimped to the crimp sleeve. In a second production variant of a connector assembly, the planar stamping pattern is bent in such a way that, in a pre-assembled state, the crimping flanks of the crimp sleeve are closed and form a sleeve-shaped crimp sleeve for axial insertion of the electrical cable. The crimp sleeve is then crimped to the outer conductor of the electrical cable until it reaches the final assembly state.

In order to prevent an undesired escape of strands of the outer cable conductor from the outer conductor crimp sleeve, EP 1 983 615 B1 suggests forming a recess on the side edge of one crimping flank and a corresponding extension on the side edge of the other crimping flank. Since the extension of the one crimping flank fits into the recess of the other crimping flank, the two crimping flanks are interlocked in the final crimped state of the crimp connection and thus prevent an outer conductor wire from escaping through a possible residual gap between the two crimping flanks.

A further outer conductor crimp sleeve according to the prior art, in which the recess formed on one crimping flank and the associated extension formed on the other crimping flank each have two undercuts, is shown in a pre-bent state in FIG. 1A and in a final bent state in FIGS. 1B and 1C. Such a “puzzle piece” geometry of the recess and the associated extension additionally stabilizes the mechanical connection between the two crimping flanks and thus makes it more difficult to break the outer conductor crimp connection if a radially directed pressure of a usually elastically acting support sleeve crimp connection acts on the outer conductor crimp connection.

During the crimping process, the side edges of the two crimping flanks of the crimp barrel are pressed together in the circumferential direction. The resulting impact forces, which act in the circumferential direction as shown in FIG. 1C, lead to a slight deformation of the puzzle-piece-shaped recess in one crimping flank and the puzzle-piece-shaped extension in the other crimping flank. As a result of the deformation, an air gap is formed between the two side edges of the crimp connection, particularly in the region of the undercuts of the recess and the extension, as indicated in FIG. 1C. This air gap between the two side edges of the crimp sleeve worsens the form fit between the two crimping flanks, which in turn disadvantageously promotes easier breaking of the crimp connection.

This is a situation that needs to be improved.

Against this background, an object of the present invention is to provide an outer conductor contact element for an electrical connector assembly which enables a mechanically stable crimp connection to the outer conductor of the electrical cable.

Accordingly, the following is provided: an outer conductor contact element for an electrical connector assembly, having, a first crimping portion for crimping an outer conductor of a cable inserted inside the outer conductor contact element to the outer conductor contact element; wherein the first crimping portion has two opposite crimping flanks, which fully circumferentially crimp or are able to crimp the outer conductor in a final assembly state, wherein, in the final assembly state; a finger-shaped extension is formed on one side edge of one crimping flank (which can also be referred to as the “first crimping flank” of the two crimping flanks), and a corresponding finger-shaped recess is formed on one side edge of the other crimping flank (which can also be referred to as the “second crimping flank” of the two crimping flanks), into which the finger-shaped extension is engaged; and wherein the finger-shaped extension and the finger-shaped recess each have at least one longitudinal extension portion with a directional component in a longitudinal axial direction of the outer conductor contact element and with a directional component transverse to the longitudinal axial direction.

The object underlying the present invention is to form two opposing crimping flanks, each with interlocking regions, in a crimping portion of the outer conductor contact element, formed as a stamped and bent part, with the outer conductor of the cable, which is referred to herein as the first crimping portion. For this purpose, a finger-shaped recess is formed on the side edge of one crimping flank, into which a corresponding finger-shaped extension, which is formed on the side edge of the other crimping flank, is engaged in the final assembly state of the electrical connector assembly. In addition, the finger-shaped extension and the finger-shaped recess each have at least one longitudinal extension portion with a directional component in a longitudinal axial direction of the outer conductor contact element and with a directional component transverse to the longitudinal axial direction of the outer conductor contact element.

Here, and in the following, “crimping flanks” can be understood in particular as the lateral end regions of a crimping region of a crimp sleeve, which are connected to each other via a support region of the crimping region of the crimp sleeve. In a pre-assembled state of the crimp sleeve, in which the pre-assembled cable can be inserted onto the support region in the crimping region of the crimp sleeve, the two crimping flanks in a first production variant of the connector assembly are preferably bent relative to an original planar crimping plate in such a way that, together with the support region, they form a U-shaped cross-sectional profile of the crimp sleeve. In a second production variant of the connector assembly, the two crimping flanks are preferably bent relative to the original planar crimping sheet in such a way that, together with the contact region, they form a sleeve-shaped cross-sectional profile of the crimp sleeve. In the final assembly state, the side edges of the two crimping flanks preferably abut each other without an air gap in between, according to both production variants. There is usually no overlap between the two crimping flanks in the final assembly state.

A “finger-shaped extension” of a crimping flank can be understood herein as a region of the crimping flank which has a certain longitudinal extension from one end, which is connected to a side edge of the crimping flank running in the longitudinal axial direction of the outer conductor contact element, to an open end. The finger-shaped extension preferably, but not necessarily, has a greater longitudinal extension than the transverse extension. The finger-shaped extension has at least one longitudinal extension portion with a directional component in the longitudinal axial direction of the outer conductor contact element and also with a directional component transverse to the longitudinal axial direction of the outer conductor contact element. In addition, the finger-shaped extension can also have, in particular in the region of its connected longitudinal end, a longitudinal extension portion in a direction transverse to the longitudinal axial direction of the outer conductor contact element and, in particular in the region of its open longitudinal end, also a longitudinal extension portion in the longitudinal axial direction of the outer conductor contact element. The at least one longitudinal extension portion with a directional component in the longitudinal axial direction of the outer conductor contact element and with a directional component transverse to the longitudinal axial direction can have a linear, curved or bent course.

A “finger-shaped recess” of a crimping flank can be understood herein as a region of the crimping flank that is exposed by the material of the crimping flank and has a certain longitudinal extension from an open outer end on the side edge of the crimping flank extending in the longitudinal axial direction of the outer conductor contact element to a closed inner end. For the formation of a finger-shaped recess of a crimping flank, the technical features mentioned herein for the finger-shaped extension of a crimping flank can apply equivalently.

Interlocked regions of the two crimping flanks can be understood in particular as regions on the side edge of one crimping flank and regions on the side edge of the other crimping flank, which are arranged intermittently with respect to each other in the final assembly state of the connector assembly without overlapping, in particular axially. The finger-shaped extension on the side edge of one crimping flank and the respective axially adjacent regions of the finger-shaped recess on the side edge of the other crimping flank preferably form mutually interlocked regions of the two crimping flanks.

The finger-shaped extension and the finger-shaped recess can each have a directional component in the longitudinal axial direction of the outer conductor contact element and a directional component transverse to the longitudinal axial direction due to the longitudinal extension portion and thus have an undercut oriented at an angle to the longitudinal axial direction.

During the crimping process, the side edges of the two crimping flanks collide and each experience an impact force in the circumferential direction. A directional component of the impact force acts vertically on the side edge of the oblique longitudinal extension portion of the finger-shaped extension, which is opposite the side edge of the finger-shaped extension in the region of the undercut. This directional component of the impact force is transmitted from the finger-shaped extension to the finger-shaped recess in the region of the undercut. In the region of the undercut of the finger-shaped extension and the finger-shaped recess in particular, the finger-shaped extension and the finger-shaped recess are thus clamped together.

Any air gap between the side edge of one crimping flank and the other crimping flank in the region of the undercut of the finger-shaped extension or the finger-shaped recess is preferably eliminated. An optimal form fit or at least a substantially optimal form fit can be realized between the two crimping flanks, which advantageously prevents the two crimping flanks from breaking open even in the case of elasticity of the support sleeve crimp connection. An air gap, which usually forms due to a manufacturing inaccuracy when punching the finger-shaped extension and the finger-shaped recess in the outer conductor contact element, can also be eliminated with a given crimping force, thus preventing the crimping wings from breaking open. The form fit between the two crimping flanks enables optimized contact resistance between the outer cable conductor and the outer conductor contact element. This also has the advantage of increasing the longitudinal or transverse tensile force on the electrical cable.

In order to enable correct and simple insertion of the finger-shaped extension into the associated finger-shaped recess, the open longitudinal end of the finger-shaped extension can be rounded, in particular in the direction of the associated undercut of the finger-shaped extension. For the same reason, the open (outer) longitudinal end of the finger-shaped recess can be rounded in the region of the undercut of the finger-shaped recess.

The finger-shaped extension on one crimping flank and the associated finger-shaped recess on the other crimping flank can be formed once or alternatively several times in the first crimping portion of the outer conductor contact element. Optionally, a further crimping portion of the outer conductor contact element, which is referred to herein as the second crimping portion, can connect axially to the first crimping portion and is used for crimping to the cable sheath of the electrical cable. Such a crimp connection can also be formed in the second crimping portion. The finger-shaped extension on one crimping flank and the associated finger-shaped recess on the other crimping flank can also be formed once or alternatively several times in the second crimping portion.

The other axial end of the first crimping portion is usually followed by a contacting portion, which forms an electrical and mechanical interface with an outer conductor mating contact element of a mating connector. The outer conductor contact element preferably has a sleeve-shaped design in the final assembly state. The outer conductor contact element can be used in a straight connector or alternatively in an angled connector. In a straight connector, the individual portions of the outer conductor contact element are arranged along the longitudinal axis of the outer conductor contact element. In an angled connector, the first and second crimping portions are arranged along a first longitudinal axis of the outer conductor contact element and the contacting portion is arranged along a second longitudinal axis, which is rotated by a certain angle to the first longitudinal axis.

The outer conductor contact element is preferably designed as a one-piece outer conductor contact element. A variant is also conceivable, which can preferably be used with an angled connector, in which the outer conductor contact element in combination with at least one other outer conductor contact element forms a multi-part outer conductor contact element solution.

The outer conductor contact element is preferably made of a bronze, brass or steel alloy. The outer conductor contact element according to the invention is preferably suitable for high-frequency connectors, but can alternatively also be used in high-voltage connectors, for example. The design of the outer conductor contact element according to the invention is particularly suitable for an outer conductor contact element that has a strong tendency to spring open. This is generally an outer conductor contact element with a thin wall thickness and/or an outer conductor contact element made of a highly resilient material, for example some bronze, brass or spring steel alloys, and/or an outer conductor contact element with a large diameter in a high-frequency connector with several inner conductor contacts.

Due to the stamping and bending process, the outer conductor contact element, with the exception of the longitudinal portion with the finger-shaped extension and the finger-shaped recess, has an abutting edge running in the longitudinal axis direction between the two side edges of the crimp plates. The joint edge between the two side edges of the crimping plates usually does not form an air gap or at most a residual air gap caused by manufacturing inaccuracies. The individual longitudinal portions of the joint edge are preferably aligned with each other. However, it is also conceivable that the longitudinal portions of the joint edge, which are each formed adjacent to the finger-shaped extension or the finger-shaped recess, are offset from each other in the circumferential direction.

Advantageous embodiments and developments can be found in the written description with reference to the figures.

It is understood that the above-mentioned features and those to be explained herein can be used not only in the combination indicated in each case, but also in other combinations or on their own, without departing from the scope of the present invention.

In a preferred embodiment of the invention, the finger-shaped extension of one crimping flank can substantially correspond to the finger-shaped recess of the other crimping flank, i.e., the shape of the finger-shaped extension substantially corresponds to the shape of the finger-shaped recess and the size of the finger-shaped extension can at most be slightly unequal to, i.e., slightly larger or slightly smaller than, the size of the finger-shaped recess due to manufacturing inaccuracies. The finger-shaped recess can therefore be at least substantially a negative shape of the finger-shaped extension. This ensures that the finger-shaped extension of one crimping flank can be engaged in the finger-shaped recess of the other crimping flank during the crimping process.

In a particularly preferred embodiment of the invention, the finger-shaped extension of one crimping flank can be designed to conform to the finger-shaped recess of the other crimping flank, i.e., the size and shape of the finger-shaped extension can be identical to the shape and size of the finger-shaped recess. This results in a preferably complete form-fit connection between the finger-shaped extension and the finger-shaped recess and thus between the two crimping flanks in the longitudinal axial direction and transverse to the longitudinal axial direction. Breaking open of the crimping wings is definitively prevented in such an embodiment.

In a further preferred embodiment of the invention, the mutually interlocked regions on the side edges of the two crimping flanks can be realized by a sequence formed on the side edge of one crimping flank comprising a finger-shaped extension and a directly adjoining finger-shaped recess and by a corresponding sequence formed on the side edge of the other crimping flank comprising a finger-shaped recess and a directly adjoining finger-shaped extension. In particular, the finger-shaped extension can merge directly into the finger-shaped recess at the side edge of one crimping flank and the finger-shaped recess can merge directly into the finger-shaped extension at the side edge of the other crimping flank in such a way that the finger-shaped extension formed at the side edge of one crimping flank and the finger-shaped extension formed at the side edge of the other crimping flank each meet in the region of the undercut.

The clamping force between the two finger-shaped extensions of the two crimping flanks acts due to the longitudinal extension portion of the two finger-shaped extensions and their side edges, which has or have a directional component in the longitudinal axial direction and a directional component transverse to the longitudinal axial direction, preferably both in the longitudinal axial direction and also transverse to the longitudinal axial direction of the outer conductor contact element.

Since a clamping force can be exerted by each of the two finger-shaped recesses on the oppositely arranged finger-shaped extension in the region of the undercut, this results in improved clamping between the two crimping flanks and improved closure of the air gap between the side edges in the region of the undercuts of the two crimping flanks compared to the formation of only one finger-shaped extension on the side edge of one crimping flank and only one finger-shaped recess on the side edge of the other crimping flank.

In order to enable correct and simple insertion of the finger-shaped extensions in the associated finger-shaped recess, the open longitudinal end of the finger-shaped extensions can be rounded, in particular in the direction of the associated undercut of the respective finger-shaped extension.

To ensure that a clamping force acts between the finger-shaped extensions of the two crimping flanks in the region of the undercuts both in the longitudinal axial direction and transverse to the longitudinal axial direction of the outer conductor contact element during the crimping process, the portions of the side edge of the two crimping flanks, which each laterally delimit the longitudinal extension portion of the finger-shaped extension, can preferably each have a course with a directional component in the longitudinal axial direction and with a directional component transverse to the longitudinal axial direction. The courses of the side edges can each have a linear course with an oblique orientation to the longitudinal axis of the outer conductor contact element or a curved or bent course.

To improve the clamping effect between the crimping flanks in the first crimping portion and optionally also in the second crimping portion, several formations consisting of a finger-shaped recess and a finger-shaped extension that can be engaged therein can be provided on the side edge of the two crimping flanks. In particular, several sequences of a finger-shaped extension and an immediately following finger-shaped recess can be formed on the side edge of one crimping flank and several sequences of a finger-shaped recess and an immediately following finger-shaped extension can be formed on the side edge of the other crimping flank. In this case, each sequence of a finger-shaped recess and an immediately following finger-shaped extension, each of which is formed on the side edge of one crimping flank, can be engaged in an associated sequence of a finger-shaped extension and an immediately following finger-shaped recess, each of which is formed on the side edge of the other crimping flank, to achieve the clamping.

If two sequences each consisting of a finger-shaped extension and an immediately following finger-shaped recess are formed on the side edge of the two crimping flanks, the finger-shaped extensions can be formed immediately one after the other on the side edge of one crimping flank and the finger-shaped recesses can be formed to enclose the finger-shaped extensions. Correspondingly, on the side edge of the other crimping flank, the finger-shaped recesses can be formed in direct succession and the finger-shaped extensions can surround the finger-shaped recesses. Such a symmetrical arrangement of the finger-shaped recesses and the finger-shaped extensions saves space in the axial direction and is therefore suitable for an outer conductor contact element with a short longitudinal extension. In the case of a longer outer conductor contact element, however, an asymmetrical arrangement with an alternating design consisting of a finger-shaped recess and a finger-shaped extension is also conceivable on the side edges of the two crimping flanks.

A trough-shaped protrusion can be formed between two finger-shaped extensions directly following each other on the lateral edge of a crimping flank. The lateral distance between the side edge in the region of the trough-shaped formation and the side edge in the region of the lateral ends of the adjacent finger-shaped extensions can be of different sizes. A small lateral distance simplifies the joining of the two crimping flanks in the crimping process. A larger lateral distance lengthens the longitudinal extension of the two finger-shaped extensions. In this case, during the crimping process, the impact force is transferred from the extended finger-shaped extension of one crimping flank to the opposite finger-shaped extension of the other crimping flank via a longer portion of the side edge in the region of the undercut and the air gap between the side edges of the opposite finger-shaped extensions is therefore closed over a longer portion of the undercut.

In the final assembly state of the outer conductor contact element, an air gap can be eliminated between the side edges of the two crimping flanks in the longitudinal portion, in which two finger-shaped extensions are formed opposite each other. However, a slight air gap of preferably less than 0.05 mmm and particularly preferably less than 0.025 mm is tolerable without jeopardizing the technical condition of a closed crimp barrel. Surprisingly, investigations have shown that such a large air gap between the side edges of the two crimping flanks already enables sufficient clamping between the two crimping flanks, which prevents the crimping wings from breaking open. Ideally, the side edges of the two crimping flanks touch each other in this longitudinal portion without an air gap, whereby an ideal form-fit connection can exist between the two crimp wings in the longitudinal axial direction and transversely to the longitudinal axial direction of the outer conductor contact element, so that a breaking open of the crimp wings can be prevented in any case. In a particularly preferred embodiment of the invention, the side edges of the two crimping wings touch each other without an air gap over their entire longitudinal extension, thus achieving a mechanically optimized clamping of the two crimping wings.

As already mentioned above, two crimping wings can also be formed in a second crimping portion of the outer conductor contact element, each with regions that are interlocked with one another. In analogy to the first crimping region, the regions of the two crimping flanks that are formed interlocked with one another can be realized by at least one finger-shaped extension formed on the side edge of one crimping flank and at least one associated finger-shaped recess formed on the side edge of the other crimping flank, into which the finger-shaped extension engages. The technical aspects already explained herein for the clamping between the two crimping wings in the first crimping portion apply equivalently to the formation of the clamping between the two crimping wings in the second crimping portion.

Since the outer diameter of the outer conductor of the electrical cable folded back around a support sleeve can be designed differently to the outer diameter of the cable sheath of the electrical cable, the outer diameter of the first crimping portion after the crimping process, i.e. in the final assembly state of the outer conductor contact element, can also be designed differently to the outer diameter of the second crimping portion.

Preferably, the outer diameter of the support sleeve can be designed relative to the outer diameter of the cable sheath such that the outer diameter of the first crimping portion after the crimping process is larger than the outer diameter of the second crimping portion. In this way, when the cable is pulled longitudinally, the support sleeve with the cable strikes axially against a step of the outer conductor contact element, which is formed by the different outer diameters of the first and second crimping portions, and thus enables the electrical cable to be fixed axially to the outer conductor contact element.

In a further preferred embodiment of the invention, the side edges of the two crimping flanks are each chamfered on the inside, i.e. on the inner surface of the sleeve-shaped outer conductor contact element. In particular, the side edges of the two crimping flanks are chamfered on the inside in such a way that one side edge and the other side edge contact each other only at an outer radial edge. In this way, strands of the outer cable conductor that are located in the region of the closing gap between the side edges of the two crimping flanks during the crimping process cannot escape into the outer region of the outer conductor contact element, but are advantageously held within the outer conductor contact element. The chamfer can preferably be formed over the entire longitudinal extent of the outer conductor contact element or alternatively only in individual portions of the longitudinal extent on the side edges of the two crimping flanks.

The invention further comprises an electrical connector assembly comprising an electrical connector and an electrical cable connected to the electrical connector. The electrical connector has an outer conductor contact element according to the invention, the first crimping portion of which is fully crimped to an outer conductor of the electrical cable. The technical features disclosed, claimed and illustrated herein with respect to the outer conductor contact element apply equivalently to the connector assembly and vice versa.

Lastly, the invention comprises a method for producing an electrical connector assembly. The method has the following steps: providing an outer conductor contact element of an electrical connector of the connector assembly with two crimping flanks in a first crimping portion, wherein a finger-shaped extension is formed on a side edge of one crimping flank and a corresponding finger-shaped recess is formed on the side edge of the other crimping flank, wherein the finger-shaped extension and the finger-shaped recess each have at least one longitudinal extension portion with a directional component in a longitudinal axial direction of the outer conductor contact element and with a directional component transverse to the longitudinal axial direction, crimping the first crimping portion to an outer conductor of an electrical cable.

In a first production variant, an outer conductor contact element is provided, the crimping flanks of which are already bent in the first crimping portion in such a way that the finger-shaped extension is engaged in the finger-shaped recess and the first crimping portion is thus shaped like a sleeve. In the pre-assembled state, the pre-assembled electrical cable is inserted into an outer conductor contact element pre-formed in such a way that the outer conductor of the electrical cable, which is folded back around a support sleeve, comes to rest in the region of the first crimping portion for the subsequent crimping process. An optionally formed second crimping portion of the outer conductor contact element, which is crimped to the cable sheath of the electrical cable during the crimping process, is equivalently already shaped in the form of a sleeve when the outer conductor contact element is provided.

In a second production variant, an outer conductor contact element is provided, the crimping flanks of which are already bent in the first crimping portion in such a way that the first crimping portion of the outer conductor contact element has a U-shaped cross-sectional profile. In the pre-assembled state, the pre-assembled electrical cable is inserted into such a pre-formed outer conductor contact element in the same way as in the first production variant.

The above embodiments and further embodiments can be combined with each other as desired, if appropriate. Other possible embodiments, developments and implementations of the invention also include combinations of features of the invention described above or in the following with regard to the exemplary embodiments. In particular, a person skilled in the art will also add individual aspects as improvements or additions to the respective basic form of the present invention.

### SUMMARY OF THE INVENTION

My invention generally provides an outer conductor contact element for an electrical cable.

A principal aspect of the present invention is an outer conductor contact element (11) for an electrical connector assembly (1), having a first crimping portion (13) for crimping an outer conductor (6) of a cable (2) inserted inside the outer conductor contact element (11) to the outer conductor contact element (11), wherein the first crimping portion (13) has two opposite crimping flanks (16) which are able to fully circumferentially crimp the outer conductor (6) in a final assembly state, wherein, in the final assembly state, a finger-shaped extension (20) is formed on one side edge (17) of one crimping flank (16) and a corresponding finger-shaped recess (19) is formed on one side edge (17) of the other crimping flank (16), into which the finger-shaped extension (20) is engaged, wherein the finger-shaped extension (20) and the finger-shaped recess (19) each have at least one longitudinal extension portion with a directional component in a longitudinal axial direction L of the outer conductor contact element (11) and with a directional component transverse to the longitudinal axial direction L.

A further aspect of the present invention is an outer conductor contact element (11), characterized in that the finger-shaped extension (20) substantially corresponds to the finger-shaped recess (19) and preferably the finger-shaped extension (20) is designed to conform to the finger-shaped recess (19).

A further aspect of the present invention is an outer conductor contact element (11) characterized in that in the final assembly state, the longitudinal extension portion of the finger-shaped extension (20) forms a form-fit connection with the longitudinal extension portion of the finger-shaped recess (19) in the longitudinal axial direction L and transversely to the longitudinal axial direction L.

A further aspect of the present invention is an outer conductor contact element (11) characterized in that on one crimping flank (16) the finger-shaped extension (20) directly follows a finger-shaped recess (19) and on the other crimping flank (16) the finger-shaped recess (19) directly follows a finger-shaped extension (20) in such a way that the finger-shaped extension (20) of one crimping flank (16) and the finger-shaped extension (20) of the other crimping flank (16) clamp each other form-fittingly in the longitudinal axial direction L and transversely to the longitudinal axial direction L.

A further aspect of the present invention is an outer conductor contact element (11) characterized in that portions of the side edge (17) of one crimping flank (16) and of the other crimping flank (16), which each laterally delimit the longitudinal extension portion of the associated finger-shaped extension (20), each have a course with a directional component in the longitudinal axial direction L and with a directional component transverse to the longitudinal axial direction L, preferably in each case a course with an oblique orientation relative to the longitudinal axial direction L.

A further aspect of the present invention is an outer conductor contact element (11) characterized in that on the side edge (17) of one crimping flank (16) a plurality of sequences each consisting of a finger-shaped extension (20) and an immediately following finger-shaped recess (19) and on the side edge (17) of the other crimping flank (16) a plurality of sequences each consisting of a finger-shaped recess (19) and an immediately following finger-shaped extension (20) are formed.

A further aspect of the present invention is an outer conductor contact element (11) characterized in that on one crimping flank (16) the finger-shaped extensions (20) of two sequences follow one another axially and are surrounded axially by the finger-shaped recesses (19) of two sequences, and on the other crimping flank (16) the finger-shaped recesses (19) of two sequences follow one another axially and are surrounded axially by the finger-shaped extensions (20) of two sequences.

A further aspect of the present invention is an outer conductor contact element (11) characterized in that in the final assembly state, an air gap with an air gap width which is preferably smaller than 0.05 mmm and particularly preferably less than 0.025 mm is formed between the side edge (17) of the one crimping flank (16) and the side edge (17) of the other crimping flank (16), and in the final assembly state the side edge (17) of the one crimping flank (16) and the side edge (17) of the other crimping flank (16) very particularly preferably touch each other without an air gap.

A further aspect of the present invention is an outer conductor contact element (11) characterized in that the first crimping portion (13) is adjoined by a second crimping portion (14) for crimping the outer conductor contact element (11) to a cable sheath (7) of the cable (2), in which the two opposing crimping flanks (16) of the first crimping portion (13) continue, wherein the finger-shaped extension (20) is formed in the second crimping portion (14) on the side edge (17) of one crimping flank (16) and the corresponding finger-shaped recess (16) is formed on the side edge (17) of the other crimping flank (16).

A further aspect of the present invention is an outer conductor contact element (11) characterized in that in the final assembly state, an outer diameter of the first crimping portion (13) is greater than an outer diameter of the second crimping portion (14) and a step (28) is formed between the first crimping portion (13) and the second crimping portion (14), on which step a support sleeve (8) of the cable (2) is supported.

A further aspect of the present invention is an outer conductor contact element (11) characterized in that the side edges (17) of the two crimping flanks (16) each have an inner-side chamfer (25) and preferably such a chamfer (25) that one side edge (17) and the other side edge (17) each contact each other only at an outer radial edge.

A further aspect of the present invention is an electrical connector assembly (1) having an electrical connector (3) and an electrical cable (2) connected to the electrical connector (3), wherein the electrical connector (3) has an outer conductor contact element (11) according to one of claims 1 to 11, the first crimping portion (13) of which is crimped fully circumferentially to an outer conductor (6) of the cable (2).

A further aspect of the present invention is a method for producing an electrical connector assembly (11) comprising the steps: providing an outer conductor contact element (11) of an electrical connector (3) of the connector assembly (1) with two crimping flanks (16) in a first crimping portion (13), wherein a finger-shaped extension (20) is formed on a side edge (17) of one crimping flank (16) and a corresponding finger-shaped recess (19) is formed on the side edge (17) of the other crimping flank (16), wherein the finger-shaped extension (20) and the finger-shaped recess (19) each have at least one longitudinal extension portion with a directional component in a longitudinal axial direction L of the outer conductor contact element (11) and with a directional component transverse to the longitudinal axial direction L, crimping the first crimping portion (13) to an outer conductor (6) of an electrical cable (2).

A still further aspect of the present invention is a production method characterized in that the provision of the outer conductor contact element (11) comprises pre-bending the two crimping flanks (16) in such a way that, in a pre-assembled state, the finger-shaped extension (20) is engaged in the finger-shaped recess (19).

An even still further aspect of the present invention is a production method characterized in that the provision of the outer conductor contact element (11) comprises pre-bending the two crimping flanks (16) in such a way that in a pre-assembled state the first crimping portion (13) of the outer conductor contact element (11) has a U-shaped cross-sectional profile.

These and other aspects of the present invention are more fully set forth and disclosed herein.

### BRIEF DESCRIPTIONS OF THE FIGURES

The present invention is explained in greater detail below with reference to the exemplary embodiments shown in the figures.

FIGS. 1A, 1B, 1C show an isometric view of a crimping portion of a pre-bent outer conductor contact element and a final bent outer conductor contact element and a side view of a crimping portion of a final bent outer conductor contact element, each according to the prior art.

FIG. 2 shows a longitudinal sectional view of an electrical connector assembly according to the invention.

FIGS. 3A, and 3B show an isometric view of a crimping portion of a pre-bent outer conductor contact element according to the invention and a final bent outer conductor contact element according to the invention.

FIGS. 4A-4K show a side view of various contemplated different versions of a crimping portion of an outer conductor contact element according to the invention.

FIGS. 5A, 5B, and 5C show a cross-sectional view of a pre-bent outer conductor contact element according to the invention and a detail of the pre-bent outer conductor contact element according to the invention and an isometric view of a final bent outer conductor contact element according to the invention.

FIGS. 6A, and 6B show an isometric view of a pre-bent outer conductor contact element according to the invention and a finally assembled outer conductor contact element according to the invention according to a first production variant.

FIGS. 7A, and 7B show an isometric view of a pre-bent outer conductor contact element according to the invention and a final assembled outer conductor contact element according to the invention according to a second production variant.

FIG. 8 shows a graphical representation of the gap dimension of various outer conductor contact elements above the internal pressure.

The accompanying figures provide a further understanding of the embodiments of the invention. They illustrate embodiments and, in conjunction with the description, serve to explain principles and concepts of the invention. Other embodiments and many of the advantages mentioned will become apparent with reference to the figures. The elements of the drawings are not necessarily shown to scale with respect to each other.

In the figures, functionally like and identically acting elements, features and components are each provided with the same reference signs, unless otherwise specified.

In the following, the figures are described coherently and comprehensively.

### DETAILED WRITTEN DESCRIPTION OF THE PREFERRED EMBODIMENTS

This disclosure of the invention is submitted in furtherance of the Constitutional purposes of the US Patent Laws “to promote the progress of Science and the useful arts” (Article 1, Section 8).

In the following, the electrical connector assembly 1 of the invention is explained with reference to the longitudinal sectional view in FIG. 2.

The connector assembly 1 comprises an electrical cable 2 and an electrical connector 3 that is electrically conductively and mechanically connected to the electrical cable 2. The electrical cable 2 has an inner conductor 4, an insulator element 5 that encases the inner conductor 4, an outer conductor 6 that encases the insulator element 5 and a cable sheath 7 that encases the outer conductor 6. At a plug-side end, the outer conductor 6 is exposed from the cable sheath 7. A support sleeve 8 is fixed to the exposed outer conductor 6, preferably by means of a crimp connection. The outer conductor 6 is folded back around the support sleeve 8. The inner conductor 4 is exposed at the plug end of the insulator element 5 and is preferably connected electrically and mechanically to an inner conductor contact element 9 of the connector 3 by means of a crimp connection. The inner conductor contact element 9 can be contacted with an inner conductor mating contact element of a mating connector and is encased by an insulator element 10 of the electrical connector 3.

A preferably sleeve-shaped outer conductor contact element 11 of the electrical connector 3 encases an axial end region of the electrical cable 2 on the one hand and the insulator element 10 of the electrical connector 3 on the other. The outer conductor contact element 11 has a contacting portion 12 for electrically contacting an outer conductor mating contact element of an electrical mating connector, an axially adjoining first crimping portion 13 for electrically conductive and mechanical connection to the outer conductor 6 folded back around the support sleeve 8, and optionally, an axially adjoining second crimping portion 14 for mechanical connection to the cable sheath 7.

The electrically conductive and mechanical connection between the first crimping portion 13 and the outer conductor 6 of the electrical cable 2 and the mechanical connection between the second crimping portion 14 and the cable sheath 7 of the electrical cable 2 are each made via a crimp connection.

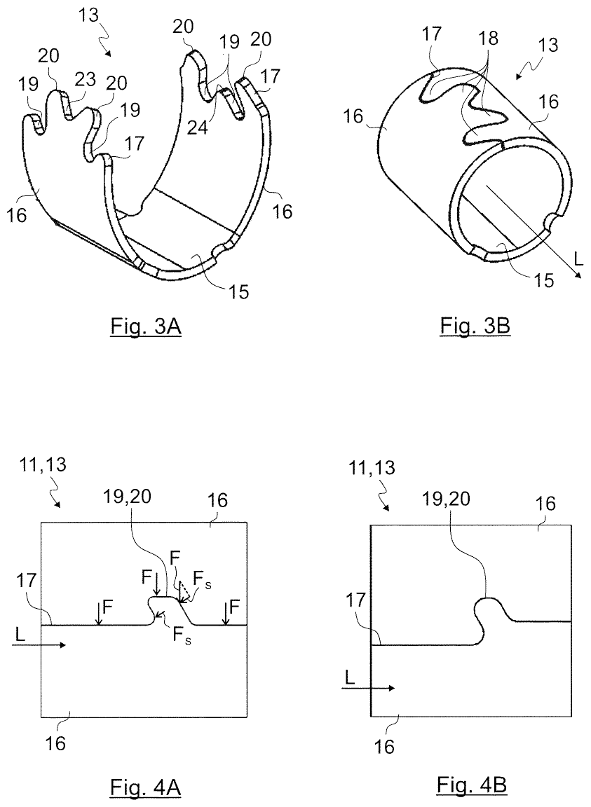

The first crimping portion 13 of the outer conductor contact element 11, which is shown in FIG. 3A in a pre-bent state, (i.e. in a pre-assembled state), and in FIG. 3B in a final bent state, (i.e. in a final assembly state), has a support region 15 for the electrical cable 2, the lateral ends of which are each adjoined by a crimping flank 16. For the sake of simplicity, the electrical cable 2 inserted into the outer conductor contact element 11 and crimped to the outer conductor contact element is not shown in FIG. 3B.

Each crimping flank 16 has a side edge 17. In the pre-bent state of the outer conductor contact element 11 according to FIG. 3A, the first crimping portion 13 with its oppositely arranged crimping flanks 16 and correspondingly oppositely arranged side edges 17 has a U-shaped cross-sectional profile. In the final bent state of the outer conductor contact element 11 according to FIG. 3B, the side edges 17 of the two crimping flanks 16 touch along their entire longitudinal extent and form a sleeve-shaped cross-sectional profile of the first crimping portion 13. As can be seen from FIG. 3B, the crimp connection in the first crimping portion 13 has two crimping flanks 16, the side edges 17 of which are each shaped in such a way that in the final bent state of the crimp connection the two crimping flanks each have interlocking regions 18.

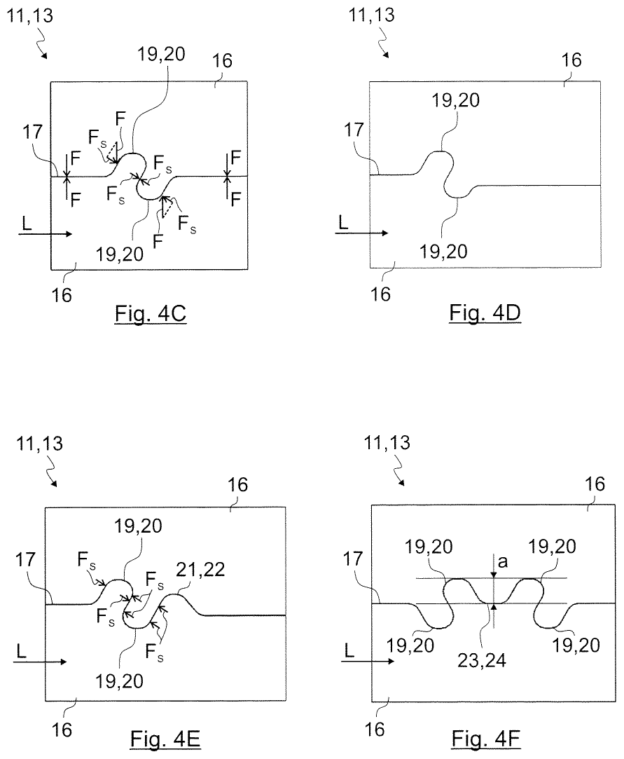

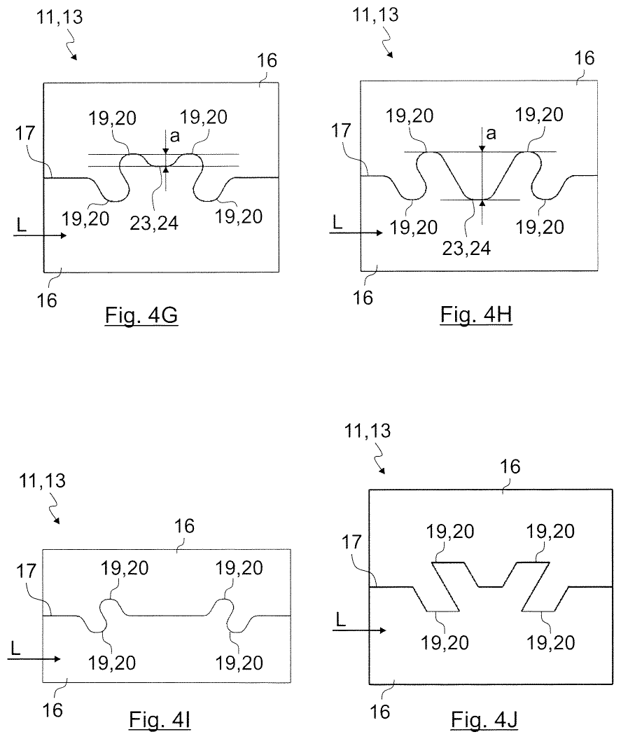

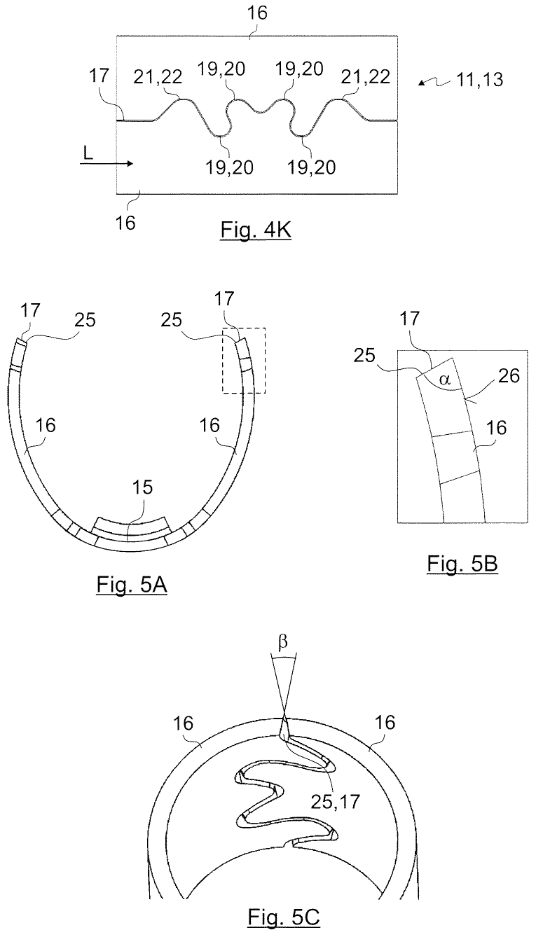

As will be explained in detail in FIGS. 4A to 4K herein, the interlocking regions 18 of the two crimping flanks 16 each have at least one finger-shaped recess 19 formed on the side edge 17 of one crimping flank 16 and an associated finger-shaped extension 20 formed on the side edge 17 of the other crimping flank 16, which is engaged in the finger-shaped recess 19. As can also be seen from FIGS. 3A, 3B and 4A to 4K, each finger-shaped recess 19 and each finger-shaped extension 20 has, in each case, at least one longitudinal extension portion with a directional component in the longitudinal axial direction L of the outer conductor contact element 11 and with a directional component transverse to the longitudinal axial direction L of the outer conductor contact element 11. In this way, the side edges 17 of the two crimping flanks 16 nestle against each other along their entire longitudinal extent without an air gap between them and thus realize an air-gap-free form-fit connection between the individual interlocked regions 18 of the two crimping flanks 17 in the longitudinal axial direction L and transversely to the longitudinal axial direction L of the outer conductor contact element 11.

The optional second crimping portion 14 of the outer conductor contact element 11 can have an equivalent shape with regard to the cross-sectional profile and an equivalent shape and equivalent arrangement of the finger-shaped recesses 19 and the finger-shaped extensions 20 on the side edges 17 of the two crimping flanks 16 to the first crimping portion 13. Alternatively, the second crimping portion 14 can also have a different shaping of the side edges 17 of the two crimping flanks 16 relative to the first crimping portion 13.

FIG. 4A shows a side view of a crimp connection according to the invention in the final assembly state of the outer conductor contact element 11, in which a finger-shaped recess 19 is formed on the side edge 17 of one crimping flank 16 and a finger-shaped extension 20 is formed on the side edge of the other crimping flank 16, which is positively engaged in the finger-shaped recess 19 in the longitudinal axial direction L and transversely to the longitudinal axial direction L without the formation of an air gap located therebetween. FIG. 4A shows the impact forces F exerted by the side edge 17 of the crimping flank 16 shown at the top in FIG. 4A on the side edge 17 of the crimping flank 16 shown at the bottom during the crimping process when the two crimping flanks 16 abut against each other, which are each directed transversely to the longitudinal axis or longitudinal axis direction L of the outer conductor contact element 11. The impact force F, which is applied from the crimping flank 16 shown at the top to the side edge 17 in the region of the longitudinal extension of the finger-shaped extension 20 of the crimping flank 16 shown at the bottom, has a force component F_{S} perpendicular to the side edge 17. The force component F_{S} is transmitted from the opposite side edge of the longitudinal extension of the finger-shaped extension 20 of the crimping flank 16 shown at the bottom to the opposite side edge of the finger-shaped recess 19 of the crimping flank 16 shown at the top. In this way, any air gap that may occur in the region of the undercut of the finger-shaped extension 20 and the finger-shaped recess 19 is advantageously closed.

FIG. 4B shows a crimp connection formed of a finger-shaped recess 19 and a finger-shaped extension 20, which is equivalent to FIG. 4A. While in the embodiment of FIG. 4A the side edges 17 of the two crimping flanks 16 are aligned with each other in the longitudinal portions of the outer conductor contact element 11 adjacent to the finger-shaped recess 19 and the finger-shaped extension 20 respectively, the side edges 17 of the two crimping flanks 16 between the two adjacent longitudinal portions are each offset in the circumferential direction, i.e., transverse to the longitudinal axis direction L.

FIG. 4C shows a further embodiment of a crimp connection in which a finger-shaped recess 19 and a finger-shaped extension 20 are formed on the side edge 17 of each of the two crimping flanks 16. At the side edge 17 of each of the two crimping flanks 16, the finger-shaped recess 19 merges directly into the finger-shaped extension 20 in such a way that the finger-shaped extensions 20 of the two crimping flanks 16 contact each other and thus clamp each other. In this case, the force component F_{S} of the impact force F of the finger-shaped extension 20 of both crimping flanks 16 acts on the respective opposite finger-shaped extension 20 of the other crimping flank 19 and a clamping in both directions is realized.

Whereas in FIG. 4C the side edges 17 of the two crimping flanks 16 are aligned with each other in the longitudinal portions adjacent to the finger-shaped extensions 20 or the finger-shaped recesses 19, in the embodiment of the crimp connection shown in FIG. 4D the side edges 17 of the two crimping flanks 16 in the adjacent longitudinal portions each have an offset transverse to the longitudinal axis L.

In the further embodiment of a crimp connection shown in FIG. 4E, an extension 21 and an associated recess 22 are formed on the side edges 17 of the two crimping flanks 16 immediately adjacent to a finger-shaped recess 19 and an associated finger-shaped extension 20 and each have a longitudinal extension only transverse to the longitudinal axis direction L. The finger-shaped extension 20 on the side edge 17 of the crimping flank 16 shown at the top in FIG. 4E has a greater longitudinal extension than the finger-shaped extension 20 on the side edge 17 of the crimping flank 16 shown at the bottom in FIG. 4E due to the additional recess 22. The force component F_{S} of the impact force F, which acts on the longer finger-shaped extension 20 and is transmitted to the opposite shorter finger-shaped extension 20, is thus distributed over a larger portion of the side edge 17 than in the shorter finger-shaped extension 20 (shown by the double arrows F_{S} in the longer finger-shaped extension 20 in contrast to the single arrow F_{S} in the shorter finger-shaped extension 20 in FIG. 4E). With such an embodiment of a crimp connection, an air gap possibly extending over a longer portion of the side edge 17 can thus be closed between two oppositely formed finger-shaped extensions 20.

FIGS. 4F to 4I show further embodiments of a crimp connection in which several sequences, in particular two sequences, each consisting of a finger-shaped recess 19 and a directly adjoining finger-shaped extension 20 are formed on the side edge 17 of the two crimping flanks 16. At the side edge 17 of one crimping flank 16, the finger-shaped extensions 20 follow one another directly axially and are each surrounded by the finger-shaped recesses 19, while at the side edge of the other crimping flank 16, the corresponding finger-shaped recesses 20 follow one another directly axially and are each surrounded by the corresponding finger-shaped extensions 20. Such a symmetrical arrangement of the finger-shaped recesses 19 and the finger-shaped extensions 20 enables a more compact arrangement of the finger-shaped recesses 19 and the finger-shaped extensions 20 in the longitudinal axial direction L.

According to the embodiments of a crimp connection shown in FIGS. 4F to 4H, the lateral distance a between the lateral edge 17 of the crimping flank 16 at the lateral ends of the two adjacent finger-shaped extensions 20 and the lateral edge of the crimping flank 16 in a trough-shaped projection 23 formed between the two adjacent finger-shaped extensions 20 can be of different sizes. A small distance (a) as shown in FIG. 4G enables the two crimping flanks 16 to be easily joined together in the crimping process, while a large distance (a) as shown in FIG. 4H realizes finger-shaped extensions 20 with a large longitudinal extension, which better closes an air gap formation between two opposing and mutually clamping finger-shaped extensions 20 over a longer portion of the side edges 17. In the final assembly state of the outer conductor contact element 11, the trough-shaped projection 23 formed on the side edge 17 of the one crimping flank 16 is engaged by a hill-shaped projection 24 formed on the side edge 17 of the other crimping flank 16.

While the finger-shaped recesses 19 and the associated finger-shaped extensions 20 of the previously explained embodiments of a crimp connection each have rounded lateral ends or rounded transitions to the adjacent longitudinal portions of the outer conductor contact element 11, the lateral ends of the finger-shaped recesses 19 and the associated finger-shaped extensions 20 in the embodiment of a crimp connection shown in FIG. 4J are each linear and have angular transitions. The formation of air gaps between the opposing finger-shaped extensions 20 is further reduced in this type of crimp connection.

Lastly, FIG. 4K shows an embodiment of a crimp connection in which, on the side edges 17 of the two crimping flanks 16, the two sequences of a finger-shaped recess 19 and an immediately following finger-shaped extension 20 are each surrounded by an extension 21 and an associated recess 22, each of which has a longitudinal extension only in a direction transverse to the longitudinal axis L.

FIGS. 5A to 5C show side edges 17 of the two crimping flanks 16 of the outer conductor contact element 11, each with an internal chamfer 25. The inner-side chamfers 25 are preferably formed in such a way that the side edges 17 of the crimping flanks 16 in the final assembly state, i.e., in the final formed state, according to FIG. 5C, only make contact on the radially outer edge in each case. The angle α between the outer surface 26 and the side edge 17 of the crimping flank 16 is less than 90°, preferably between 70° and 90°, due to the chamfer 25. This results in a preferred value of between 20° and 40° for the angle β between the two chamfered side edges 17. In this way, strands of the outer conductor 6 of the cable 2, which are located between the two side edges 17 of the crimping flanks 16 during the crimping process, are displaced radially inwards into the outer conductor contact element 11.

FIG. 6A shows an outer conductor contact element 11 for a connector assembly 1 in a pre-assembled state, i.e., in a pre-bent state, which is produced according to a first variant of a production process for the connector assembly 1. In the exemplary illustration of FIGS. 6A and 6B, the outer conductor contact element 11 for an angled connector 3 is angled. It has a first crimping portion 13 for crimping with the outer conductor 6 of the electrical cable 2, a contacting portion 12 angled towards it and a connecting portion 27 located between them and aligned with the first crimping portion 13. According to the first variant of the production method for the connector assembly 1, the first crimping portion 13 and the connecting portion 27 of the outer conductor contact element 11 are each pre-bent in a U-shape in order to insert the pre-assembled electrical cable 2. In the final assembly state as shown in FIG. 6B, the first crimping portion 13 and the connecting portion 27 are each shaped like sleeves. The outer conductor 6 of the electrical cable 2 is crimped to the outer conductor contact element 11 in the first crimping portion 13.

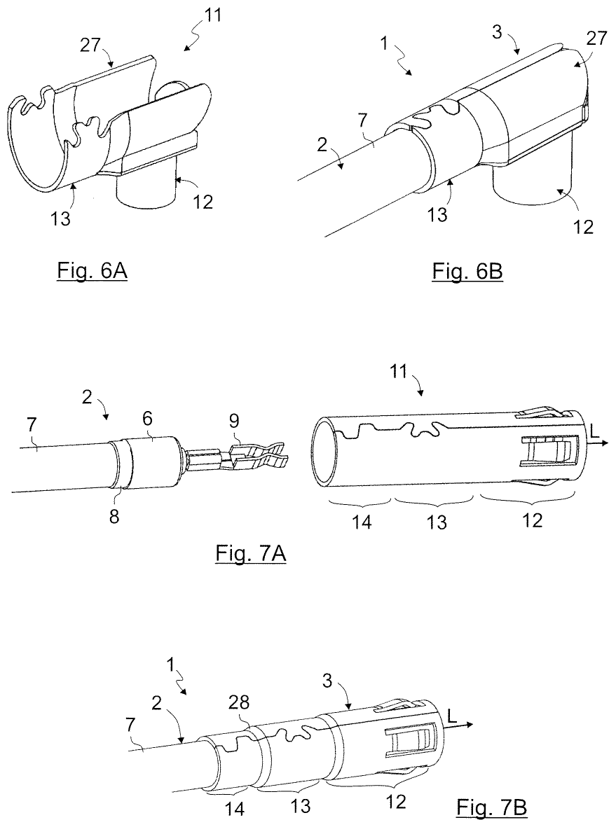

FIG. 7A shows a pre-assembled electrical cable 2 and an outer conductor contact element 11 separated therefrom, which is produced according to a second variant of a production method for a connector assembly 1. In the exemplary illustration in FIGS. 7A and 7B, the outer conductor contact element 11 is designed for a straight connector 3 and has a contacting portion 12, a first crimping portion 13 and additionally a second crimping portion 14 for crimping with a cable sheath 7 of the electrical cable 2. As can be seen from FIG. 7A, the first crimping portion 13 has a crimp connection according to the invention with finger-shaped recesses 19 and finger-shaped extensions 20, the longitudinal extension of which each have a directional component in the longitudinal axial direction L and a directional component transverse to the longitudinal axial direction L. The second crimping portion 14, on the other hand, has a conventional crimp connection according to the prior art. The outer conductor contact element 11, which is produced according to the second variant of a production method for a connector assembly 1, is pre-formed in a sleeve shape in the pre-assembled state according to FIG. 7A. The pre-assembled cable 2 is inserted into the sleeve-shaped pre-formed outer conductor contact element 11. In the final assembly state as shown in FIG. 7B, the first crimping portion 13 is crimped to the outer conductor 6 of the electrical cable 2 and the second crimping portion 14 is crimped to the cable sheath 7 of the cable 2. FIG. 7B shows that the outer diameter of the first crimping portion 13 is larger than the outer diameter of the second crimping portion 14, so that the electrical cable 2 with the support sleeve 8 attached to the outer conductor 6 abuts against the step 28 formed by the outer diameter step and thus an improved axial fixing is formed between the electrical cable 2 and the electrical connector 3.

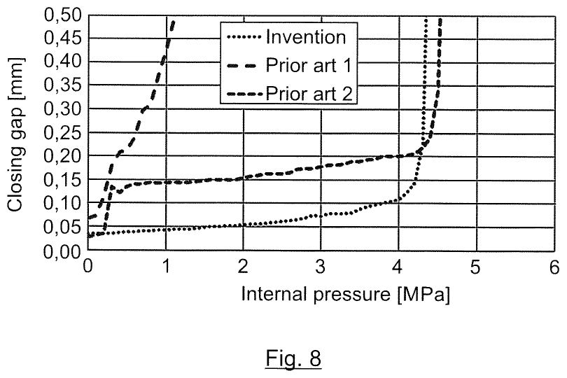

FIG. 8 shows a comparison of the functional quality of several outer conductor crimp connections that were simulated for different crimping principles. The functional quality is determined here by the relationship between the internal pressure, which is caused by the crimping flanks of the support sleeve cracking open, and the resulting closing gap, i.e. the size of the air gap between the side edges of the two crimping flanks 16 in the final assembly state of the outer conductor contact element 11.

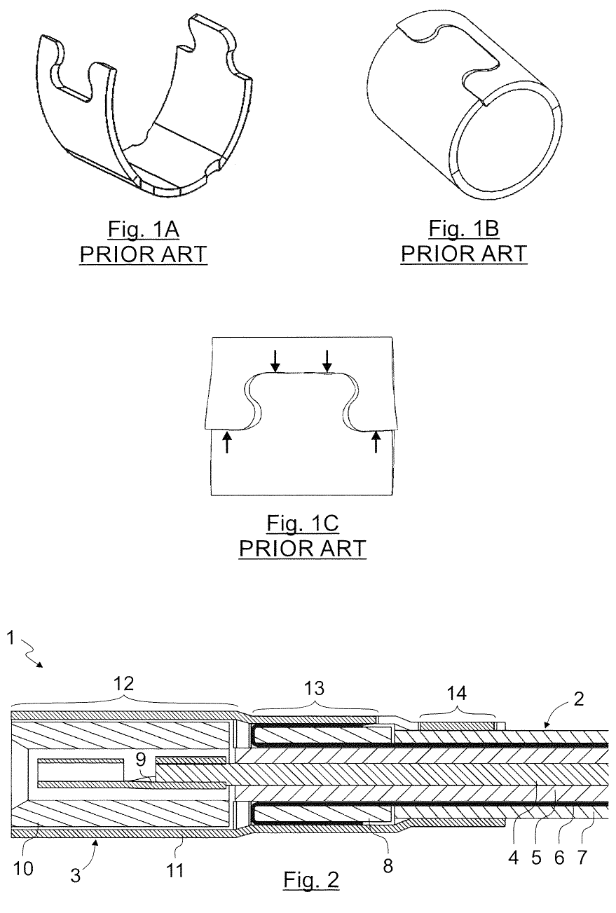

In the case of an outer conductor crimp connection according to the principle of EP 1 983 615 B1 (Prior art 1 in FIG. 8), even a very low internal pressure leads to the crimp connection opening. In the case of an outer conductor crimp connection according to the principle of FIGS. 1A to 1C (Prior art 2 in FIG. 2), a maximum permissible closing gap of usually 0.1 mm is also achieved at a low internal pressure. In the outer conductor crimp connection according to the invention (Invention in FIG. 8), the permissible closing gap is only exceeded at an internal pressure of 4 MPa, which does not usually occur with conventional connector geometries and connector materials.

Although the present invention has been fully described above with reference to preferred exemplary embodiments, it is not limited thereto, but can be modified in a variety of ways.

### Operation

Having described the structure of our Plug Connector Assembly and Plug Connection, its operation is briefly described.

The connector assembly 1 which comprises an electrical cable 2 and an electrical connector 3 that is electrically conductively and mechanically connected to the electrical cable 2. The electrical cable 2 has an inner conductor 4, an insulator element 5 that encases the inner conductor 4, an outer conductor 6 that encases the insulator element 5 and a cable sheath 7 that encases the outer conductor 6. At a plug-side end, the outer conductor 6 is exposed from the cable sheath 7. A support sleeve 8 is fixed to the exposed outer conductor 6, preferably by means of a crimp connection. The outer conductor 6 is folded back around the support sleeve 8. The inner conductor 4 is exposed at the plug end of the insulator element 5 and is preferably connected electrically and mechanically to an inner conductor contact element 9 of the connector 3 by means of a crimp connection. The inner conductor contact element 9 can be contacted with an inner conductor mating contact element of a mating connector and is encased by an insulator element 10 of the electrical connector 3.

A principal object of the present invention is an outer conductor contact element (11) for an electrical connector assembly (1) for connection to an electrical cable (2) that has an outer conductor (6), the outer conductor contact element (11) comprising: a first crimping portion (13) for crimping the outer conductor (6) of the electrical cable (2); and wherein the first crimping portion (13) has two opposite crimping flanks (16) which together fully circumferentially crimp the outer conductor (6) of the electrical cable (2) in a final assembly state; and a finger-shaped extension (20) is formed on one side edge (17) of one crimping flank (16), and a corresponding finger-shaped recess (19) is formed on one side edge (17) of the other crimping flank (16); and wherein, in the final assembly state the finger-shaped extension (20) of the one side edge (17) of the one crimping flank (16) is engaged within the finger-shaped recess (19) defined in the one side edge (17) of the other crimping flank (6); and each of the finger-shaped extension (20) and the finger-shaped recess (19) have at least one longitudinal extension portion with a directional component in a longitudinal axial direction (L) of the outer conductor contact element (11); and each of the finger-shaped extension (20) and the finger-shaped recess (19) have at least one longitudinal extension portion with a directional component transverse to the longitudinal axial direction (L) of the outer conductor contact element (11).

A further object of the present invention is an outer conductor contact element (11) wherein the finger-shaped extension (20) substantially corresponds to the finger-shaped recess (19).

A further object of the present invention is an outer conductor contact element (11) wherein in the final assembly state, the longitudinal extension portion of the finger-shaped extension (20) forms a form-fit connection with the longitudinal extension portion of the finger-shaped recess (19) in the longitudinal axial direction (L) and transversely to the longitudinal axial direction (L).

A further object of the present invention is an outer conductor contact element (11) wherein the finger-shaped extension (20) on the one crimping flank (16) directly follows a finger-shaped recess (19); and on the other crimping flank (16) the finger-shaped recess (19) directly follows a finger-shaped extension (20) so that the finger-shaped extension (20) of one crimping flank (16) and the finger-shaped extension (20) of the other crimping flank (16) clamp each other form-fittingly in the longitudinal axial direction (L) of the outer conductor contact element (11) and clamp each other form-fittingly transversely to the longitudinal axial direction (L) of the outer conductor contact element (11).

A further object of the present invention is an outer conductor contact element (11) wherein portions of the side edge (17) of the one crimping flank (16) and portions of the side edge (17) of the other crimping flank (16), which each laterally delimit the longitudinal extension portion of the associated finger-shaped extension (20), each have a course with a directional component in the longitudinal axial direction (L) and have a course with a directional component transverse to the longitudinal axial direction (L) of the outer conductor contact element (11).

A further object of the present invention is an outer conductor contact element (11) and further comprising: a plurality of sequences defined in the side edge (17) of the one crimping flank (16), each sequence consisting of a finger-shaped extension (20) and an immediately following finger-shaped recess (19); and a plurality of sequences defined in the side edge (17) of the other crimping flank (16), each sequence consisting of a finger-shaped recess (19) and an immediately following finger-shaped extension (20).

A further object of the present invention is an outer conductor contact element (11) and wherein on one crimping flank (16) the finger-shaped extensions (20) of two sequences follow one another axially and are surrounded axially by the finger-shaped recesses (19) of two sequences; and on the other crimping flank (16) the finger-shaped recesses (19) of two sequences follow one another axially and are surrounded axially by the finger-shaped extensions (20) of two sequences.

A further object of the present invention is an outer conductor contact element (11) and wherein in the final assembly state, an air gap with an air gap width which is smaller than 0.05 mmm is formed between the side edge (17) of the one crimping flank (16) and the side edge (17) of the other crimping flank (16).

A further object of the present invention is an outer conductor contact element (11) and further comprising: a second crimping portion (14) for crimping the outer conductor contact element (11) to a cable sheath (7) of the electrical cable (2), the second crimping portion (14) adjoining the first crimping portion (13); and wherein the two opposing crimping flanks (16) of the first crimping portion (13) extend into the second crimping portion; and the finger-shaped extension (20) is formed in the second crimping portion (14) on the side edge (17) of one crimping flank (16); and the finger-shaped recess (16) that corresponds with the finger-shaped extension (20) formed in the second crimping portion (14) is formed on the side edge (17) of the other crimping flank (16).

A further object of the present invention is an outer conductor contact element (11) and wherein in the final assembly state, an outer diameter of the first crimping portion (13) is greater than an outer diameter of the second crimping portion (14); and a step (28) is formed between the first crimping portion (13) and the second crimping portion (14); and a support sleeve (8) of the electrical cable (2) is supported on the step (28) between the first crimping portion (13) and the second crimping portion (14).

A further object of the present invention is an outer conductor contact element (11) and wherein the side edges (17) of the two opposite crimping flanks (16) each have an inner-side chamfer (25).

A further object of the present invention is an electrical connector assembly (1) comprising: an electrical connector (3); and an electrical cable (2) connected to the electrical connector (3); and wherein the electrical connector (3) has an outer conductor contact element (11), which has a first crimping portion (13) for crimping an outer conductor (6) of the electrical cable (2), and wherein the first crimping portion (13) has two opposite crimping flanks (16) which together fully circumferentially crimp the outer conductor (6) of the electrical cable (2) in a final assembly state, and a finger-shaped extension (20) is formed on one side edge (17) of one crimping flank (16), and a corresponding finger-shaped recess (19) is formed on one side edge (17) of the other crimping flank (16), and wherein, in the final assembly state the finger-shaped extension (20) of the one side edge (17) of the one crimping flank (16) is engaged within the finger-shaped recess (19) defined in the one side edge (17) of the other crimping flank (6), and each of the finger-shaped extension (20) and the finger-shaped recess (19) have at least one longitudinal extension portion with a directional component in a longitudinal axial direction (L) of the outer conductor contact element (11), and each of the finger-shaped extension (20) and the finger-shaped recess (19) have at least one longitudinal extension portion with a directional component transverse to the longitudinal axial direction (L) of the outer conductor contact element (11); and the first crimping portion (13) is crimped fully circumferentially to the outer conductor (6) of the electrical cable (2).

A further object of the present invention is a method for producing an electrical connector assembly (1) comprising the steps: providing an outer conductor contact element (11) of an electrical connector (3) of the electrical connector assembly (1), the outer conductor contact element (11) having a first crimping portion (13) that has two opposite crimping flanks (16), each of the two opposite crimping flanks (16) having a side edge (17), wherein a finger-shaped extension (20) is formed on the side edge (17) of one crimping flank (16) and a corresponding finger-shaped recess (19) is formed on the side edge (17) of the other crimping flank (16), and wherein the finger-shaped extension (20) and the finger-shaped recess (19) each have at least one longitudinal extension portion with a directional component in a longitudinal axial direction (L) of the outer conductor contact element (11) and each finger-shaped extension (20) and each finger-shaped recess (19) has at least one longitudinal extension portion with a directional component transverse to the longitudinal axial direction (L) of the outer conductor contact element (11); and crimping the first crimping portion (13) to an outer conductor (6) of an electrical cable (2).

A further object of the present invention is a method for producing an electrical connector assembly (1) wherein the step of providing the outer conductor contact element (11) further comprises a step of pre-bending the two opposite crimping flanks (16) so that, in a pre-assembled state, the finger-shaped extension (20) is engaged in the finger-shaped recess (19).

A further object of the present invention is a method for producing an electrical connector assembly (1) wherein the step of providing the outer conductor contact element (11) further comprises a step of pre-bending the two opposite crimping flanks (16) so that in a pre-assembled state the first crimping portion (13) of the outer conductor contact element (11) has a U-shaped cross-sectional profile.

A further object of the present invention is an outer conductor contact element (11) wherein the finger-shaped extension (20) is designed to conform to the finger-shaped recess (19).

A further object of the present invention is an outer conductor contact element (11) wherein in the final assembly state, an air gap with an air gap width which is smaller than 0.025 mm is formed between the side edge (17) of the one crimping flank (16) and the side edge (17) of the other crimping flank (16).

A further object of the present invention is an outer conductor contact element (11) wherein in the final assembly state the side edge (17) of the one crimping flank (16) and the side edge (17) of the other crimping flank (16) touch each other without an air gap.

A still further object of the present invention is an outer conductor contact element (11) wherein the side edges (17) of the two opposite crimping flanks (16) each have an inner-side chamfer (25) so that one side edge (17) and the other side edge (17) each contact each other only at an outer radial edge.

An even still further object of the present invention is an outer conductor contact element (11) wherein portions of the side edge (17) of the one crimping flank (16) and portions of the side edge (17) of the other crimping flank (16), which each laterally delimit the longitudinal extension portion of the associated finger-shaped extension (20), each have a course with an oblique orientation relative to the longitudinal axial direction (L) of the outer conductor contact element (11).

In compliance with the statute, the present invention has been described in language more or less specific, as to structural and methodical features. It is to be understood, however, that the invention is not limited to the specific features shown and described since the means herein disclosed comprise preferred forms of putting the invention into effect. The invention is, therefore, claimed in any of its forms or modifications within the proper scope of the appended claims appropriately interpreted in accordance with the Doctrine of Equivalents.

1. An outer conductor contact element (11) for an electrical connector assembly (1) for connection to an electrical cable (2) that has an outer conductor (6), the outer conductor contact element (11) comprising:
a first crimping portion (13) for crimping the outer conductor (6) of the electrical cable (2); and wherein
the first crimping portion (13) has two opposite crimping flanks (16) which together fully circumferentially crimp the outer conductor (6) of the electrical cable (2) in a final assembly state; and
a finger-shaped extension (20) is formed on one side edge (17) of one crimping flank (16), and a corresponding finger-shaped recess (19) is formed on one side edge (17) of the other crimping flank (16); and wherein, in the final assembly state
the finger-shaped extension (20) of the one side edge (17) of the one crimping flank (16) is engaged within the finger-shaped recess (19) defined in the one side edge (17) of the other crimping flank (6); and
each of the finger-shaped extension (20) and the finger-shaped recess (19) have at least one longitudinal extension portion with a directional component in a longitudinal axial direction (L) of the outer conductor contact element (11); and
each of the finger-shaped extension (20) and the finger-shaped recess (19) have at least one longitudinal extension portion with a directional component transverse to the longitudinal axial direction (L) of the outer conductor contact element (11).

2. Outer The outer conductor contact element (11) as claimed in claim 1 and wherein the finger-shaped extension (20) substantially corresponds to the finger-shaped recess (19).

3. Outer The outer conductor contact element (11) as claimed in claim 1 and wherein, characterized in that in the final assembly state, the longitudinal extension portion of the finger-shaped extension (20) forms a form-fit connection with the longitudinal extension portion of the finger-shaped recess (19) in the longitudinal axial direction (L) and transversely to the longitudinal axial direction (L).

4. Outer The outer conductor contact element (11) as claimed in claim 1 and wherein the finger-shaped extension (20) on the one crimping flank (16) directly follows a finger-shaped recess (19); and
on the other crimping flank (16) the finger-shaped recess (19) directly follows a finger-shaped extension (20) so that the finger-shaped extension (20) of one crimping flank (16) and the finger-shaped extension (20) of the other crimping flank (16) clamp each other form-fittingly in the longitudinal axial direction (L) of the outer conductor contact element (11) and clamp each other form-fittingly transversely to the longitudinal axial direction (L) of the outer conductor contact element (11).

5. The outer conductor contact element (11) as claimed in claim 4 and wherein, characterized in that portions of the side edge (17) of the one crimping flank (16) and portions of the side edge (17) of the other crimping flank (16), which each laterally delimit the longitudinal extension portion of the associated finger-shaped extension (20), each have a course with a directional component in the longitudinal axial direction (L) and have a course with a directional component transverse to the longitudinal axial direction (L) of the outer conductor contact element (11).

6. The outer conductor contact element (11) as claimed in claim 4 and further comprising:
a plurality of sequences defined in the side edge (17) of the one crimping flank (16), each sequence consisting of a finger-shaped extension (20) and an immediately following finger-shaped recess (19); and
a plurality of sequences defined in the side edge (17) of the other crimping flank (16), each sequence consisting of a finger-shaped recess (19) and an immediately following finger-shaped extension (20).

7. The outer conductor contact element (11) as claimed in claim 6 and wherein on one crimping flank (16) the finger-shaped extensions (20) of two sequences follow one another axially and are surrounded axially by the finger-shaped recesses (19) of two sequences; and,
on the other crimping flank (16) the finger-shaped recesses (19) of two sequences follow one another axially and are surrounded axially by the finger-shaped extensions (20) of two sequences.

8. The outer conductor contact element (11) as claimed in claim 1 and wherein, in the final assembly state, an air gap with an air gap width which is smaller than 0.05 mmm is formed between the side edge (17) of the one crimping flank (16) and the side edge (17) of the other crimping flank (16).

9. The outer conductor contact element (11) as claimed in claim 1 and further comprising:
a second crimping portion (14) for crimping the outer conductor contact element (11) to a cable sheath (7) of the electrical cable (2), the second crimping portion (14) adjoining the first crimping portion (13); and wherein in
the two opposing crimping flanks (16) of the first crimping portion (13) extend into the second crimping portion; and
the finger-shaped extension (20) is formed in the second crimping portion (14) on the side edge (17) of one crimping flank (16); and
the finger-shaped recess (16) that corresponds with the finger-shaped extension (20) formed in the second crimping portion (14) is formed on the side edge (17) of the other crimping flank (16).

10. The outer conductor contact element (11) as claimed in claim 9 and wherein in the final assembly state, an outer diameter of the first crimping portion (13) is greater than an outer diameter of the second crimping portion (14); and
a step (28) is formed between the first crimping portion (13) and the second crimping portion (14); and
a support sleeve (8) of the electrical cable (2) is supported on the step (28) between the first crimping portion (13) and the second crimping portion (14).

11. The outer conductor contact element (11) as claimed in claim 1 and wherein the side edges (17) of the two opposite crimping flanks (16) each have an inner-side chamfer (25).

12. Electrical A electrical connector assembly (1) comprising:
an electrical connector (3); and
an electrical cable (2) connected to the electrical connector (3); and wherein
the electrical connector (3) has an outer conductor contact element (11),
which has
a first crimping portion (13) for crimping an outer conductor (6) of the electrical cable (2), and wherein
the first crimping portion (13) has two opposite crimping flanks (16) which together fully circumferentially crimp the outer conductor (6) of the electrical cable (2) in a final assembly state, and
a finger-shaped extension (20) is formed on one side edge (17) of one crimping flank (16), and a corresponding finger-shaped recess (19) is formed on one side edge (17) of the other crimping flank (16), and wherein, in the final assembly state
the finger-shaped extension (20) of the one side edge (17) of the one crimping flank (16) is engaged within the finger-shaped recess (19) defined in the one side edge (17) of the other crimping flank (6), and
each of the finger-shaped extension (20) and the finger-shaped recess (19) have at least one longitudinal extension portion with a directional component in a longitudinal axial direction (L) of the outer conductor contact element (11), and
each of the finger-shaped extension (20) and the finger-shaped recess (19) have at least one longitudinal extension portion with a directional component transverse to the longitudinal axial direction (L) of the outer conductor contact element (11); and
the first crimping portion (13) is crimped fully circumferentially to the outer conductor (6) of the electrical cable (2).

13. A method for producing an electrical connector assembly (1) comprising the steps:
providing an outer conductor contact element (11) of an electrical connector (3) of the electrical connector assembly (1), the outer conductor contact element (11) having a first crimping portion (13) that has two opposite crimping flanks (16), each of the two opposite crimping flanks (16) having a side edge (17), and wherein a finger-shaped extension (20) is formed on the side edge (17) of one crimping flank (16) and a corresponding finger-shaped recess (19) is formed on the side edge (17) of the other crimping flank (16), and wherein the finger-shaped extension (20) and the finger-shaped recess (19) each have at least one longitudinal extension portion with a directional component in a longitudinal axial direction (L) of the outer conductor contact element (11) and each finger-shaped extension (20) and each finger-shaped recess (19) has at least one longitudinal extension portion with a directional component transverse to the longitudinal axial direction (L) of the outer conductor contact element (11); and
crimping the first crimping portion (13) to an outer conductor (6) of an electrical cable (2).

14. Production The method for producing an electrical connector assembly (1) as claimed in claim 13 and wherein the step of providing the outer conductor contact element (11) further comprises a step of pre-bending the two opposite crimping flanks (16) so that, in a pre-assembled state, the finger-shaped extension (20) is engaged in the finger-shaped recess (19).

15. Production The method for producing an electrical connector assembly (1) as claimed in claim 13 and wherein the step of providing outer conductor contact element (11) further comprises a step of pre-bending the two opposite crimping flanks (16) so that in a pre-assembled state the first crimping portion (13) of the outer conductor contact element (11) has a U-shaped cross-sectional profile.

16. The outer conductor contact element (11) as claimed in claim 1 and wherein the finger-shaped extension (20) is designed to conform to the finger-shaped recess (19).

17. The outer conductor contact element (11) as claimed in claim 1 and wherein in the final assembly state, an air gap with an air gap width which is smaller than 0.025 mm is formed between the side edge (17) of the one crimping flank (16) and the side edge (17) of the other crimping flank (16).

18. The outer conductor contact element (11) as claimed in claim 1 and wherein in the final assembly state the side edge (17) of the one crimping flank (16) and the side edge (17) of the other crimping flank (16) touch each other without an air gap.

19. The outer conductor contact element (11) as claimed in claim 1 and wherein the side edges (17) of the two opposite crimping flanks (16) each have an inner-side chamfer (25) so that one side edge (17) and the other side edge (17) each contact each other only at an outer radial edge.

20. The outer conductor contact element (11) as claimed in claim 4 and wherein portions of the side edge (17) of the one crimping flank (16) and portions of the side edge (17) of the other crimping flank (16), which each laterally delimit the longitudinal extension portion of the associated finger-shaped extension (20), each have a course with an oblique orientation relative to the longitudinal axial direction (L) of the outer conductor contact element (11).
